(19) United States
(12) Patent Application Publication
(10) Pub. No.: US 2010/0196662 A1
(43) Pub. Date: Aug. 5, 2010

(54) TRANSPARENT CONDUCTIVE MATERIAL

(75) Inventors: Masutatsu MASHIMO, Tokyo (JP); Noriyuki YASUDA, Tokyo (JP); Kazuhisa INABA, Tokyo (JP)

Correspondence Address: OLIFF & BERRIDGE, PLC, P.O. BOX 320850, ALEXANDRIA, VA, 22320-4850, US

(73) Assignee: TDK CORPORATION, Tokyo (JP)

(21) Appl. No.: 12/690,548

(22) Filed: Jan. 20, 2010

(30) Foreign Application Priority Data
Jan. 30, 2009 (JP) P2009-019732

(51) Int. Cl. B32B 3/10

(52) U.S. Cl. 428/141

(57) ABSTRACT

An object of the present invention is to provide a transparent conductive material that can prevent cracks or abrasions on the conductive layer due to repeated use, while maintaining a high conductivity. The transparent conductive material of the present invention has a conductive layer 4 containing a binder 3 and conductive particles 2 held with the binder. In the transparent conductive material, at least a portion of some of the conductive particles 2 is exposed on an outermost surface of the conductive layer, and a fluorine compound is unevenly present on an exposed surface of the conductive particles exposed on the outermost surface of the conductive layer.

### BACKGROUND OF THE INVENTION

1. Field of the Invention

The present invention relates to a transparent conductive material.

2. Related Background Art

Panel switches such as resistive touch panels (hereinafter “touch panels”), in general, include a pair of transparent electrodes positioned opposite each other and a spacer sandwiched between the pair of transparent electrodes. When one of the transparent electrodes is pressed, this transparent electrode is contacted with the other transparent electrode to conduct an electric current, whereby the location of the contact point is detected. Transparent conductive materials are used as such transparent electrodes. Examples of transparent conductive materials include one in which a conductive layer containing a conductive powder and a resin is formed (see Japanese Patent Laid-Open No. Hei-11-227740).

When these transparent conductive materials are used in touch panels, opposite transparent conductive materials are contacted with each other to cause friction between them.

For this reason, repeated use of touch panels can result in cracks or abrasions on the conductive layers of transparent conductive materials due to friction. This may cause variation in resistance, or degrade the linearity of resistance. Additionally, characteristics such as abrasion resistance and sliding properties may be degraded.

Thus, a proposal has been made to improve the durability of the surface of a conductive layer by treating the surface of the conductive layer with a chain polymer compound (see Japanese Patent Laid-Open No. 2006-85867).

### SUMMARY OF THE INVENTION

However, although the durability is improved using the above-described method of treating the surface of a conductive layer, the surface resistance of electrode surfaces tends to increase, easily causing the conductivity to decrease. In some applications, transparent conductive materials having a conductive layer with a high conductivity are required; in these cases, it has been difficult to improve the durability while maintaining a high conductivity.

In view of the circumstances described above, an object of the present invention is to provide a transparent conductive material that can prevent cracks or abrasions on the conductive layer due to repeated use, while maintaining a high conductivity.

To achieve the above-mentioned object, the transparent conductive material of the present invention includes a conductive layer containing a binder and conductive particles held with the binder; wherein at least a portion of some of the conductive particles is exposed on a surface of the conductive layer, and a fluorine compound is unevenly present on an exposed surface of the conductive particles exposed on the surface of the conductive layer.

As a result of inventors' research, the present inventors found that, in the conductive layer containing a conductive powder and a resin of the transparent conductive material, a portion of the conductive powder is often exposed on the surface of the conductive layer, and this exposed portion of the conductive powder is one cause of the formation of cracks or abrasions due to the contact between opposite conductive layers. Specifically, conductive particles made of a transparent conductive oxide material are widely employed as the conductive particles forming a conductive powder. However, transparent conductive materials containing these particles of a transparent conductive oxide material generally have poor surface smoothness, and have large frictional resistance due to their tendency to have high surface energies because of the presence of OH groups on the surfaces. These properties, in particular, easily caused cracks or abrasions.

In contrast to this, in the transparent conductive material of the present invention, the fluorine compound is unevenly adhered to the portion of the conductive particles exposed on the outermost surface of the conductive layer, resulting in reduced friction on the surface of the conductive layer, and particularly on the exposed portion of the conductive particles. Thus, even in applications such as touch panels and the like in which the transparent conductive materials are positioned opposite each other, the friction produced when the conductive layers are contacted is suppressed; as a result, the conductive layers are unlikely to develop cracks or abrasions. Moreover, the fluorine compound is present not on the entire surface of the conductive layer, but on a portion of the surface region of the outermost surface on which conductive particles are exposed. This suppresses an increase in resistance on the surface of the conductive layer due to the fluorine compound, thereby allowing a high conductivity to be maintained.

In the transparent conductive material of the present invention, the fluorine compound is preferably present only on the exposed surface of the conductive particles exposed on the outermost surface of the conductive layer. This further enhances the above-mentioned effects.

Furthermore, the fluorine compound is preferably chemically bonded to the exposed surface of the conductive particles exposed on the outermost surface of the conductive layer. Chemical bonding of the fluorine compound prevents bleeding of the fluorine compound or adhesion of the fluorine compound to the opposite electrode. Thus, the effect of suppressing the friction can be attained more easily, and this effect can be maintained for a long period of time.

The transparent conductive material of the present invention can prevent cracks or abrasions of the conductive layer due to repeated use, while maintaining a high conductivity, thereby realizing sufficient durability.

### BRIEF DESCRIPTION OF THE DRAWINGS

FIG. 1 is a schematic cross section showing a preferred embodiment of a transparent conductive material.

FIG. 2 is an enlarged schematic cross section showing a portion near the outermost surface of the conductive layer.

### DESCRIPTION OF THE PREFERRED EMBODIMENTS

Preferred embodiments of the present invention will be described in detail below, referring to the drawings, as necessary. In the drawings, like reference numerals denote like elements, and the same description will be omitted. The dimensional proportions of the drawings are not limited to those shown therein.

[Transparent Conductive Material]

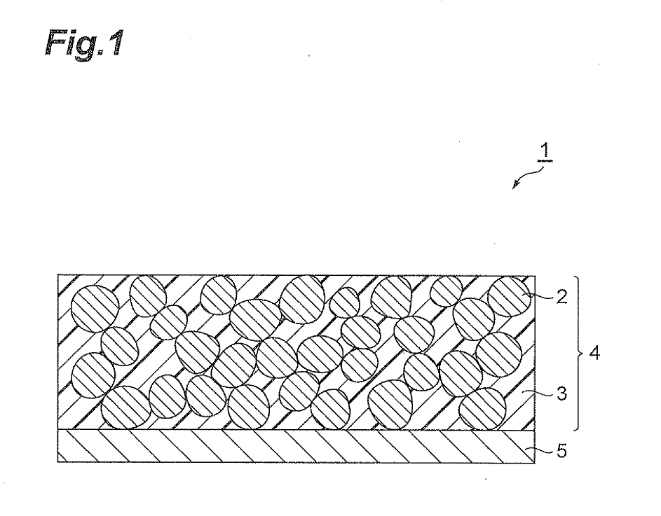

A transparent conductive material according to a preferred embodiment is first described. FIG. 1 is a schematic cross section showing a preferred embodiment of a transparent conductive material 1. As shown in FIG. 1, the transparent conductive material 1 includes a conductive layer 4 containing a binder 3 and conductive particles 2 held within the binder 3 with the binder 3; and a substrate 5, on which the conductive layer 4 is formed.

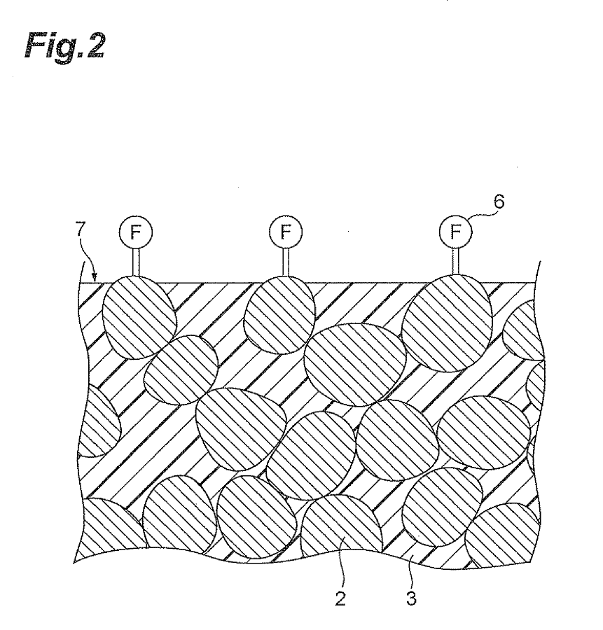

FIG. 2 is an enlarged schematic cross section showing a portion near an outermost surface 7 of the conductive layer 4. FIG. 2 shows that, although not clearly depicted in FIG. 1, a portion of conductive particles 2 present near the outermost surface is exposed on the outermost surface 7 (the surface opposite the substrate 5) of the conductive layer 4, and a fluorine compound 6 is present on the exposed surface. The fluorine compound 6 is thus adhered to the outermost surface 7 of the conductive layer 4; specifically, the fluorine compound is unevenly present on the exposed surface of the exposed conductive particles 2.

As used herein, the state that “the fluorine compound is unevenly present on the exposed surface of the conductive particles” means that the fluorine compound is present on a portion of the exposed surface of the conductive particles, and does not mean that the fluorine compound spreads evenly to form a uniform layer on the outermost surface of the conductive layer. That is, some of the conductive particles are exposed, and the fluorine compound is adhered to at least a portion of the exposed surface. However, the fluorine compound may also be present on the surface of the binder 3; as long as the fluorine compound 6 is present more on the exposed surface of the conductive particles 2 than on the surface of the binder 3, this state is included within the aspect in which “the fluorine compound is unevenly present on the exposed surface of the conductive particles”.

In FIG. 2, one fluorine compound 6 is bonded to one conductive particle 2, for the sake of simplicity; however, the present invention is not limited to this embodiment, and a plurality of fluorine compounds 6 may be bonded to one conductive particle 2. Instead of being chemically bonded, the fluorine compound 6 may also be physically adhered. As described above, the fluorine compound 6 may be adhered to at least a portion of the surface of the exposed conductive particles 2. However, it is preferred that the fluorine compound 6 is adhered to 50% or more of the exposed conductive particles 2, in order to advantageously achieve the effects described below.

Preferably, the fluorine compound 6 is present only on the exposed surface of the conductive particles 2 exposed on the outermost surface of the conductive layer 4, in order to reduce friction while advantageously maintaining a high conductivity of the conductive layer 4, as described below. The state that “the fluorine compound is present only on the exposed surface of the conductive particles” means, for example, that the fluorine compound 6 is not detected on any portion other than on the exposed surface of the conductive particles 2, as measured by X-ray photoelectron spectroscopy.

When the above-described transparent conductive material 1 is used, for example, in touch panel applications, adjacent transparent conductive materials 1 are positioned opposite each other so that the conductive layers 4 face opposite each other. In this case, the transparent conductive materials 1 are placed so that the opposite surfaces of the conductive layers 4 (i.e., the surfaces subject to friction due to the contact between the conductive layers 4) are the above-mentioned surfaces to which the fluorine compound 6 is adhered, thereby making it possible to reduce the formation of cracks or abrasions caused by repeated contact between the conductive layers 4. The transparent conductive material is not exclusively used in touch panel applications, and can also be suitably used for applications such as antistatic materials, heating elements, antennas, electromagnetic radiation shields, switches, optical filters, transparent electrodes, and the like.

The fluorine compound 6, conductive layer 4, conductive particles 2, binder 3, and substrate 5 in the transparent conductive material 1 will be described below in detail.

<Fluorine Compound>

The transparent conductive material 1 has the fluorine compound 6 on the outermost surface of the conductive layer 4. The presence of the fluorine compound 6 on the surface enhances the lubricity of the surface of the conductive layer 4. Thus, when the transparent conductive material 1 is used in touch panel applications, the friction between transparent conductive materials 1 positioned opposite each other can be reduced, enabling the prevention of cracks or abrasions on the surfaces of the conductive layers 4. This can also suppress variation in electrical resistance.

Further, because the fluorine compound 6 is unevenly present on the exposed surface of the conductive particles 2, rather than on the entire outermost surface of the conductive layer 4, an increase in resistance on the surface of the conductive layer 4 is suppressed, as compared to cases where the fluorine compound 6 is present on the entire surface as a layer; thus, a high conductivity of the transparent conductive material 1 is maintained. Specific examples of the fluorine compound 6 are described below.

The fluorine compound is not particularly limited, and may be any compound containing one or more fluorine atoms in its molecule. Examples of such fluorine compounds include perfluoropolyethers and derivatives thereof; fluorine-containing alcohols such as 2-perfluorodecyl ethanol; fluorine-containing acid halides such as perfluorooctanoyl fluoride; fluorine-containing acids such as perfluorodecanoic acid; fluorine-containing acrylates such as 2-(perfluorooctyl)ethyl acrylate; fluorine-containing methacrylates such as 2-(perfluoro-5-methylhexyl)ethyl methacrylate; perfluoro(2,5,8,11-tetramethyl-3,6,9,12-tetraoxapentadecanoyl)fluoride; perfluoropolyoxetane and derivatives thereof; 3-perfluorohexyl-1,2-epoxypropane; di-heptadecatrifluorodecyldisilazane; heptadecatrifluorodecyltrimetoxysilane; and 1H,1H-heptadecafluorononylamine. These compounds may be used alone or as a mixture of two or more.

The fluorine compound preferably has a larger number of fluorine atoms, and more preferably, is a perfluoro compound in which all of the hydrogen atoms have been replaced by fluorine atoms. This further enhances the lubricity of the outermost surface of the conductive layer on which the fluorine compound is present.

A commercially available fluorine compound or a compound obtained by polymerizing a fluorine-containing monomer, dimer, trimmer, tetramer, oligomer, or the like (hereinafter referred to as a “monomer or the like”) may be used as the fluorine compound. The fluorine compound may also be a copolymer of a monomer or the like not containing fluorine and a fluorine-containing monomer or the like. Examples of the fluorine-containing monomer or the like include 2-(perfluorooctyl)ethyl acrylate and 2-(perfluoro-5-methylhexyl)ethyl methacrylate.

The fluorine compound may also be one obtained by using a compound not containing fluorine, and then replacing the hydrogen atoms by fluorine atoms in a separate step. The fluorination reaction for the compound not containing fluorine can be carried out according to a known method, using a fluorine gas, electrophilic fluorinating agent, nucleophilic fluorinating agent, or the like for the compound not containing fluorine. Moreover, the surface of the conductive layer 4 may be directly fluorinated using any of the above-mentioned fluorinating agents or the like.

Furthermore, the fluorine compound may be one obtained by using a compound not containing fluorine, and then chemically bonding the compound with a fluorine-containing short-chain compound in a separate step. Examples of such short-chain compounds include 2,3,4,5,6-pentafluorophenoxyacetyl chloride and 2,3,4,5,6-pentafluorobenzamide.

The fluorine compound preferably has a linear molecule. In the transparent conductive material of the invention, the use of a fluorine compound having a linear molecule can enhance the lubricity of the outermost surface of the conductive layer 4 on which the fluorine compound is present. Specific examples of such fluorine compounds include linear perfluoropolyethers and derivatives thereof; and heptadecatrifluorodecyl trimethoxysilane. Linear perfluoropolyethers are preferred.

The fluorine compound preferably has four carbon atoms, and more preferably eight or more carbon atoms, that constitute its main chain. A fluorine compound having such a main chain tends to further increase the lubricity of the surface of the conductive layer 4.

As described above, the fluorine compound is unevenly adhered to the exposed surface of the conductive particles 2 exposed on the outermost surface of the conductive layer 4. The adhesion of the fluorine compound may include both adhesion by physical means such as electrostatic attraction and adhesion by the formation of chemical bonds; however, it is preferred that the fluorine compound is chemically bonded to the exposed surface of the conductive particles, in order to advantageously cause the fluorine compound to be unevenly present. In this case, even if the fluorine compound may be present on portions other than the exposed surface of the conductive particles 2 (for example, on the surface of the binder 3), it is preferably not bonded to the surface of the binder 3.

Chemical bonding of the fluorine compound to the conductive particles or other surfaces can be confirmed by, for example, measurement using X-ray photoelectron spectroscopy. If any chemical bond has been formed, the condition of the chemical bond can be analyzed by this measurement. In addition to this method, other examples of methods include one in which the surface of the conductive layer 4 to which the fluorine compound is adhered is washed with a solvent such as methyl ethyl ketone, and then the contact angle of the water on the washed surface is measured. If the fluorine compound is chemically bonded, it will not be removed by this washing; hence, if no variation is observed in the contact angle of the water prior to and after the washing, the fluorine compound is confirmed to be chemically bonded to the surface of the conductive particles 2.

Preferably, the chemical bond between the fluorine compound and the exposed surface of the conductive particles is specifically formed by the reaction between the functional group of the fluorine compound and the functional group of the surface of the conductive particles. Examples of functional groups of the surface of the conductive particles include OH groups when the conductive particles are formed of a transparent conductive oxide material such as ITO, as described below. The functional group is preferably present on end(s) of the linear chain in the molecular structure of a linear fluorine compound; and more preferably, the fluorine compound is a monovalent compound. This is effective in that the fluorine compound can be arranged on the surface of the conductive particles more selectively.

In order to achieve this chemical bond, the fluorine compound preferably has a functional group that can react with (bonded to) the functional group present on the surface of the conductive particles. In this case, the “fluorine compound” being present on the surface of the conductive layer 4 has a structure formed after the functional group in the original fluorine compound has reacted.

Examples of substituents for the fluorine compound that can be bonded to the surface of the conductive particles include groups containing a polymerizable double bond, such as acryloyl, methacryloyl, and styrene groups, that can be bonded by photo- or heat radical polymerization; epoxy groups that react in the presence of water, an acid, alkali, or catalyst, or by heat, etc.; hydroxy groups; alkoxy groups; ester groups; acyl groups such as acyl halide; halogen groups; silane groups such as alkoxysilane, chlorosilane, and silazane groups; carboxylic acid groups; amide groups; and amine groups.

Specific examples of fluorine compounds that can be easily present on the surface of the exposed conductive particles 2 include 3,3,3-trifluoropropyltrimethoxysilane, 1,1,2,2-tetrahydroperfluorohexyltrimethoxysilane, 1,1,2,2-tetrahydroperfluorooctyltrimethoxysilane, 1,1,2,2-tetrahydroperfluorodecyltriethoxysilane, 1,1,2,2-tetrahydroperfluorododecyltriethoxysilane, 1,1,2,2-tetrahydroperfluorotetradecyltriethoxysilane, (3-pentafluorophenyl)propyltrimethoxysilane, and the like; compounds having fluorine-containing silane groups, such as bis(trifluoropropyl)tetramethyldisiloxane and bis(trifluoropropyl)tetramethyldisilazane; fluorine-containing halogen compounds such as 3,3,3-trifluoropropyldimethylchlorosilane, pentafluorophenyldimethylchlorosilane, and (3-pentafluoroisopropoxy)propyltrichlorosilane; and fluorine-containing compounds having epoxy groups or oxetane groups that react in the presence of water, an acid, alkali, or catalyst, or by heat, etc. These fluorine compounds may be used alone or in a combination of two or more.

<Conductive Layer>

As described above, the conductive layer 4 has a binder 3 and a plurality of conductive particles 2 held with the binder 3. Some of the plurality of conductive particles 2 near the surface of the conductive layer 4 are partially uncovered with the binder 3 and protruding from the surface. The conductive layer 4 preferably includes a region where adjacent conductive particles 2 are continuously placed in contact with each other; and more preferably, most of adjacent conductive particles 2 are in contact with each other. In other words, the conductive layer 4 advantageously has a structure in which a large number of conductive particles 2 are aggregated, with the binder 3 bonding these particles. With this structure, the conductive layer 4 can advantageously function as a conductive material.

First, the conductive particles 2 are preferably formed of a transparent conductive oxide material. The transparent conductive oxide material is not particularly limited as long as it is transparent and conductive. Examples of such transparent conductive oxide materials include indium oxide or indium oxide doped with at least one element selected from the group consisting of tin, zinc, tellurium, silver, gallium, zirconium, hafnium, and magnesium; tin oxide or tin oxide doped with at least one element selected from the group consisting of antimony, zinc, and fluorine; zinc oxide or zinc oxide doped with at least one element selected from the group consisting of aluminum, gallium, indium, boron, fluorine, and manganese; and titanium oxide doped with niobium or tantalum.

The conductive particles 2 preferably have an average particle size of 10 to 80 nm. If the average particle size is less than 10 nm, the conductivity of the transparent conductive material 1 tends to vary easily, as compared to cases where the average particle size is 10 nm or more. More specifically, the transparent conductive material 1 of this embodiment exhibits conductivity mainly due to an oxygen deficiency induced in the conductive particles 2. If the particle size of the conductive particles 2 is less than 10 nm, the conductive particles are highly reactive to oxygen, as compared to cases where the particle size is within the above-defined range. Therefore, the oxygen deficiency will easily decrease, possibly resulting in variation in conductivity. Conversely, if the average particle size exceeds 80 nm, the scattering of light will be increased in, for example, the wavelength region of visible light, as compared to cases where the particle size is within the above-defined range, i.e., 80 nm or less. Hence, the transmittance of the transparent conductive material 1 tends to decrease in the wavelength region of visible light, causing the haze value to increase.

The content of the conductive particles 2 in the transparent conductive material 1 is preferably 40 to 97 mass %. If the content is less than 40 mass %, the electrical resistance of the transparent conductive material 1 tends to increase, as compared to cases where the content is within the above-defined range. Conversely, if the content exceeds 97 mass %, the mechanical strength of the film forming the conductive layer 4 tends to decrease, as compared to cases where the content is within the above-defined range. Thus, when the average particle size and content of the conductive particles 2 are within the above-defined ranges, the transparency of the transparent conductive material 1 can be further enhanced, and the initial electrical resistance can be reduced.

The conductive particles 2 preferably have a specific surface area of 10 to 50 m²/g. If the specific surface area of the conductive particles 2 is less than 10 m²/g, the scattering of visible light tends to increase, as compared to cases where the specific surface area is within the above-defined range. Conversely, if the specific surface area exceeds 50 m²/g, the conductivity of the transparent conductive material 1 tends to be unstable, as compared to cases where the specific surface area is within the above-defined range. The specific surface area as referred to herein is a value measured using a specific surface area analyzer (model: NOVA2000, manufactured by Quantachrome Instruments) after vacuum-drying the sample at 300° C. for 30 minutes.

The conductive layer 4 may further contain additives, as required. Examples of additives include a flame retardant, an UV absorbent, a radical scavenger, a coloring agent, a plasticizer, a binder, a coupling agent, a filler, a leveling agent, a surfactant, and the like.

The binder 3 is preferably formed of a resin. The resin forming the binder 3 is not particularly limited as long as it is a transparent resin that can hold the conductive particles 2. Specific examples of such resins include conductive polymers such as acrylic resins, epoxy resins, polystyrenes, polyurethanes, silicone resins, fluororesins, polyacetylenes, polyphenylenes, polyphenylenevinylenes, polysilanes, polyfluorenes, polythiophenes, polypyrroles, and polyanilines. These resins may be used alone or as a mixture of a plurality of resins. Moreover, a plurality of resins among the above may be used in physically or chemically bonded form. A cured product of a photocurable compound, thermosetting compound, or the like can also be used as the binder 3. The photocurable compound may be any organic compound that is cured using light, and the thermosetting compound may be any organic compound that is cured using heat. An organic compound that is cured using an electron beam that is a high energy beam may also be used. The above-mentioned organic compounds also include substances that form the binder 3; specific examples of such substances include a monomer, dimer, trimmer, oligomer, and the like that can form the binder 3.

<Substrate>

The substrate 5 is not particularly limited as long as it is formed of a material transparent to visible light. When a photocurable compound is used as the binder 3, the substrate 5 is also preferably transparent to the high energy beam used for curing the compound. Examples of the substrate 5 include polyester films such as polyethylene terephthalate (PET), polyolefin films such as polyethylene and polypropylene, polycarbonate films, acrylic films, norbornene films (“Arton” manufactured by JSR Corporation, “Zeonor” manufactured by Zeon Corporation, etc.), polyethersulfone (PES), and the like. In addition to these resin films, glass can also be used as the substrate 5.

The substrate 5 is preferably formed of only a resin. In this case, the transparency and flexibility of the transparent conductive material are improved, as compared to cases where the substrate 5 contains a resin and a material other than a resin. Therefore, this is particularly effective when the transparent conductive material 1 is used for, for example, touch panels.

While the transparent conductive material 1 according to preferred embodiments has been described above, the transparent conductive material of the present invention is not necessarily limited to those of the foregoing embodiments, as long as it includes a structure in which the fluorine compound 6 is unevenly adhered to the conductive layer 4, as described above. For example, the transparent conductive material may only include a conductive layer 4 and a fluorine compound 6, without having a substrate 5. Further, the transparent conductive material may also include another resin layer or the like between the substrate 5 and the conductive layer 4.

[Method for Producing the Transparent Conductive Material]

A preferred method for producing the above-described transparent conductive material 1 is next described. In this embodiment, a predetermined substrate is first prepared, and then a conductive powder formed of a large number of conductive particles 2 is placed on the substrate. The substrate used herein is a substrate for forming a conductive layer 4 thereon (hereinafter referred to as a “substrate for forming a conductive layer”), and may, for example, be a glass substrate. An anchor layer may be formed beforehand on the substrate for forming a conductive layer, in order to hold the conductive powder onto the substrate. The formation of such an anchor layer beforehand allows the conductive powder to be tightly held onto the substrate for forming a conductive layer, enabling easy placement of the conductive powder. The anchor layer is preferably formed of a layer of, for example, a polyurethane or silicone resin.

Conductive particles 2 forming the conductive powder can be prepared as follows. When tin-doped indium oxide is used, indium chloride and tin chloride are coprecipitated by neutralization with an alkali (precipitation step). The by-product salt formed in this step is removed by decantation or centrifugation. The resulting coprecipitate is dried, and the dried product is baked in an atmosphere and ground, thus yielding conductive particles 2. Baking is preferably carried out in a nitrogen atmosphere or a noble gas atmosphere such as helium, argon, or xenon, from a viewpoint of controlling the oxygen deficiency. Baking is also preferably carried out in a reducing atmosphere. To create a reducing atmosphere, hydrogen, carbon monoxide, or a general reducing agent can be used as a reducing agent in the above-mentioned nitrogen or noble gas.

The conductive powder may be placed on the substrate for forming a conductive layer by, for example, the following method. A dispersion in which the conductive powder is dispersed in a solvent such as ethanol is prepared. The dispersion is applied to the substrate for forming a conductive layer, and the solvent is subsequently evaporated. The conductive powder may also be compressed toward the substrate for forming a conductive layer, in order to hold the conductive powder onto the substrate. This compression can be carried out using a sheet press, roll press, or the like.

Next, the binder 3 is applied to the conductive powder placed on the substrate for forming a conductive layer, allowing the binder 3 to penetrate into gaps between the conductive particles 2 forming the conductive powder. The binder 3 may also be applied in the form of a solution mixed with a solvent or the like. When a material that requires curing such as a photocurable resin is used as the binder 3, the binder 3 is preferably applied prior to curing. The solvent used for application is subsequently evaporated, thus forming a resin layer in which the binder 3 (or the binder 3 prior to curing) has penetrated through the conductive powder.

The substrate 5 is pressure-bonded to the resulting resin layer. When the binder 3 prior to curing is used, the binder 3 is cured. Subsequently, the substrate for forming a conductive layer is peeled off. Consequently, a conductive layer 4 in which the conductive powder (conductive particles 2) is held with the binder 3 is formed on the substrate 5. On the surface opposite the substrate 5 of the thus-obtained conductive layer 4, a portion of some of the conductive particles 2 present near the surface is exposed.

When the binder 3 is, for example, a curable compound, curing of the binder 3 can be carried out by irradiating the compound with a high energy beam through the substrate 5. Examples of usable high energy beams include ultraviolet rays, electron beams, γ-rays, X-rays, and the like. When the binder 3 is a thermosetting compound, it can be suitably cured by heating.

In addition to the above-described method for forming a conductive layer 4, the following method may also be used. For example, a conductive material in which the binder 3 (or the binder 3 prior to curing) and conductive powder are dispersed in a solvent is prepared. This conductive material is applied to the substrate 5, and the solvent is evaporated. The binder 3 is subsequently cured to form a conductive layer 4.

A conductive layer 4 in which the conductive powder (conductive particles 2) is held with the binder 3 can be formed according to any of the above-mentioned methods; however, according to the previously-described method in which the binder 3 is penetrated through the conductive powder afterward, it is also possible to allow the binder 3 to remain in an upper portion of the conductive powder, thereby forming a conductive layer 4, and simultaneously forming a resin layer formed of only the binder 3 between the substrate 5 and the conductive layer 4.

A conductive layer 4 may also be directly formed on the substrate 5 without using the above-described substrate for forming a conductive layer.

After a conductive layer 4 is formed on the substrate 5, as described above, the fluorine compound is adhered to the surface of the conductive layer 4 opposite the substrate 5 (the surface 7 in FIG. 2) so that it is unevenly present on the exposed surface of the conductive particles 2 exposed on the surface of the conductive layer 4, as described above. This results in the transparent conductive material 1 having the structure shown in FIGS. 1 and 2.

The fluorine compound 6 can be introduced into (adhered to) the surface 7 of the conductive layer 4 by, for example, applying a dilute solution of the fluorine compound 6 to the conductive layer 4, followed by removing the solvent and the like. In this manner, the fluorine compound 6 can be unevenly adhered to the exposed surface of the conductive particles 2.

Specifically, when the fluorine compound has a functional group that reacts with the functional group of the surface of the conductive particles 2, these functional groups react with each other upon the application, causing the fluorine compound 6 to be chemically bonded to the surface of the conductive particles 2. In order to advantageously achieve this bonding, heat treatment or the like may be performed after the application of the dilute solution of the fluorine compound 6. The heating for evaporating the solvent may be utilized for this purpose.

When a compound that forms the above-mentioned bond is used as the fluorine compound 6, after the adhesion of the fluorine compound 6, the surface of the conductive layer 4 to which the compound is adhered may be washed with a solvent or the like. This will advantageously remove the fluorine compound not being bonded to the surface of the conductive particles 2, allowing the fluorine compound 6 to be unevenly present more advantageously.

The dilute solution containing the fluorine compound preferably has a concentration of 0.1 to 0.001%, and more preferably 0.07 to 0.003%. The use of a dilute solution at a preferable concentration allows the fluorine compound 6 to be adhered selectively to the surface of the conductive particles 2 exposed on the surface of the conductive layer 4. If the concentration of the dilute solution is less than 0.001%, the fluorine compound may not be effectively adhered, resulting in an inability to sufficiently enhance the lubricity of the surface of the conductive layer 4. Conversely, if the concentration exceeds 0.1%, the fluorine compound 6 will be adhered in excess to the surface of the conductive layer 4. In touch panel applications, this may cause the adhesion of an excess of the fluorine compound 6 to an electrode surface opposite the conductive layer 4, causing the conductivity between electrodes to decrease.

Examples of methods that can be used to apply the dilute solution of the fluorine compound 6 include a reverse roll method, a direct roll method, a blade method, a knife method, an extrusion method, a nozzle method, a curtain method, a gravure roll method, a bar coating method, a dip method, a kiss coating method, a spin coating method, a squeeze method, a spray method, and the like.

Another example of a method for introducing the fluorine compound 6 may be as follows. A specific adsorbent material is adsorbed beforehand on a portion of the functional groups present on the exposed surface of the conductive particles 2. A solution of the fluorine compound is further applied to the thus-treated surface, allowing the fluorine compound 6 to be bonded to the functional groups of the conductive particles on which the adsorbent material is not adsorbed; subsequently, the adsorbent material is removed by heating or the like. In this manner, the amount of the fluorine compound 6 to be bonded can be controlled. This method may allow the fluorine compound 6 to be unevenly present on the surface of the conductive particles 2 particularly advantageously.

### EXAMPLES

The present invention will be described in greater detail below, referring to the Examples; however, the invention is not limited to these Examples.

### Preparation of Transparent Conductive Materials

### Example 1

A polyethylene terephthalate (PET) film (manufactured by Toray Industries, Inc.; thickness: 50 μm) having an anchor layer (manufactured by Panasonic Electric Works Co., Ltd.) as a substrate was prepared. An ITO dispersion coating liquid containing a powder of tin-doped indium oxide (hereinafter referred to as “ITO”) and ethanol (the average particle size of the ITO powder: 30 nm, solids concentration: 25%) was applied to this film using a bar coating method. After the application, the ethanol was evaporated, and an ITO powder was further held onto the anchor layer using a roll press. In this manner, an ITO powder layer compression-formed on the substrate was formed.

Next, a solution of a photocurable acrylic resin composition was applied to the ITO powder layer using a bar coating method. The solution of the acrylic resin composition used herein was prepared by mixing 20 parts by mass of an acrylic polymer (manufactured by Taisei Kako Co., Ltd.); 20 parts by mass of a UV-curable resin solution (manufactured by Nagase & Co., Ltd.); 60 parts by mass of dipentaerythritol hexaacrylate (manufactured by Shin-Nakamura Chemical Co., Ltd.); 3 parts by mass of a photopolymerization initiator (manufactured by Ciba Specialty Chemicals, Inc.); and 150 parts by mass of methyl ethyl ketone (MEK).

After the application of the acrylic resin composition solution, the MEK was evaporated to form a resin layer. A PET film (Teijin Limited; thickness: 100 μm) for use as a substrate was subsequently pressure-bonded on this resin layer. The acrylic resin composition was then cured by irradiating the resin layer through the PET film substrate with UV light at a cumulative dose of 400 mJ/cm² from a metal halide lamp as the light source. In this manner, a conductive layer in which the ITO particles were held with the cured product of the acrylic resin composition (the binder) was formed. At this time, a resin layer formed of only the cured product of the acrylic resin composition that was not allowed to penetrate into the ITO powder was also formed between the conductive layer and the PET film substrate.

The PET film used first was then peeled off, and a dilute solution (0.1 wt %) of hydrolyzed trifluoropropyltrimetoxysilane (manufactured by Shin-Etsu Chemical Co., Ltd.) in MEK was applied to the exposed conductive layer using a bar coating method; subsequently, the applied solution was dried at 100° C. for 1 hour.

As a result, a transparent conductive material was produced in which the resin layer and conductive layer were formed in this order on the substrate, and the fluorine compound was bonded to the surface of some of the conductive particles positioned on the outermost surface of the conductive layer.

### Example 2

In the same manner as in Example 1, a conductive layer was formed, and then a PET film was peeled off. A dilute solution (0.05 mass %) of 1,1,2,2-tetrahydroperfluorotetradecyltriethoxysilane (manufactured by Gelest, Inc.) in a fluorine solvent was applied to the conductive layer using a bar coating method, and the solvent was dried; the resulting conductive layer was subsequently allowed to stand for 5 hours in an environment at 85° C. and 85% RH. The resulting conductive layer was then immersed in a fluorine solvent, thus producing a transparent conductive material from which an excess of the fluorine compound was removed.

### Example 3

A transparent conductive material was produced in the same manner as in Example 2, except that 1,1,2,2-tetrahydroperfluorotetradecyltriethoxysilane (manufactured by Gelest, Inc.) used in Example 2 was replaced by 1,1,2,2-tetrahydroperfluorodecyltrichlorosilane.

### Comparative Example 1

A transparent conductive material was produced in the same manner as in Example 2, except that 0.05 mass % of the dilute solution of 1,1,2,2-tetrahydroperfluorotetradecyltriethoxysilane in the fluorine solvent used in Example 2 was replaced by 3.0 mass % of the same dilute solution. As a result, a fluorine compound layer was formed so as to cover substantially the entire surface of the conductive layer.

### Comparative Example 2

A transparent conductive material was produced in the same manner as in Example 1, except that no treatment was applied to the conductive layer of Example 1.

[Evaluation of the Transparent Conductive Materials]

### (Measurement of Resistance of the Transparent Conductive Materials)

The surface electrical resistance of each of the thus-obtained transparent conductive materials was measured using a 4-pin probe surface resistance meter (MCP-T600, manufactured by Mitsubishi Chemical Corporation). The measured results are shown in Table 1.

(Measurement of Coefficients of Kinetic Friction of the Transparent Conductive Materials)

Friction was evaluated for each of the thus-obtained transparent conductive materials as follows. First, each transparent conductive material was cut into 100×300 mm and 63×63 mm. The PET substrate side of the transparent conductive material cut into 100×300 mm was fixed to a measurement table using a double-sided adhesive tape. Next, a reinforcing plate having a traction line was attached to the PET substrate side of the transparent conductive material cut into 63×63 mm using the double-sided adhesive tape. The conductive layer side of the 63×63 mm transparent conductive material was subsequently placed on the conductive layer of the transparent conductive material fixed on the measurement table so that both of the conductive layers were opposite each other. A weight of 200 g was then placed thereon, and a coefficient of kinetic friction was measured using Autograph AGS-G (manufactured by Shimadzu Corporation). The measured results are shown in Table 1.

TABLE 1

| | Surface | |
|---|---|---|
| | Resistance | Coefficient of |
| | (kΩ/sq) | Kinetic Friction |
| Ex. 1 | 0.84 | 0.156 |
| Ex. 2 | 0.87 | 0.144 |
| Ex. 3 | 0.86 | 0.148 |
| Comp. Ex. 1 | 161 | 0.120 |
| Comp. Ex. 2 | 0.83 | 0.780 |

As shown in Table 1, when the fluorine compound was bonded to a portion of the conductive particles exposed on the surface of the conductive layer (Examples 1 to 3), the surface resistance was low, and the coefficient of kinetic friction was low. This confirmed that these transparent conductive materials can maintain a high conductivity when used in touch panels or the like, and also unlikely develop cracks or abrasions even after repeated use. Conversely, the transparent conductive material of Comparative Example 1 in which the fluorine compound layer was formed on substantially the entire surface of the conductive layer had a significantly high surface resistance; and the transparent conductive material of Comparative Example 2 that was not subjected to a treatment using a fluorine compound had a high coefficient of kinetic friction.

What is claimed is:

1. A transparent conductive material comprising a conductive layer comprising a binder and conductive particles dispersed in the binder; wherein:
at least a portion of some of the conductive particles is exposed on a surface of the conductive layer; and
a fluorine compound is unevenly present on an exposed surface of the conductive particles exposed on the surface of the conductive layer.

2. The transparent conductive material according to claim 1, wherein the fluorine compound is chemically bonded to the exposed surface of the conductive particles exposed on the surface of the conductive layer.
